(19) United States
(12) Patent Application Publication
(10) Pub. No.: US 2012/0110633 A1
(43) Pub. Date: May 3, 2012

(54) APPARATUS FOR SHARING SECURITY INFORMATION AMONG NETWORK DOMAINS AND METHOD THEREOF

(75) Inventors: Gaeil An, Daejeon (KR); Sungwon Yi, Daejeon (KR); Ki Young Kim, Daejeon (KR); Jonghyun Kim, Daejeon (KR)

(73) Assignee: Electronics and Telecommunications Research Institute, Daejeon (KR)

(21) Appl. No.: 13/182,972

(22) Filed: Jul. 14, 2011

(30) Foreign Application Priority Data
Oct. 29, 2010 (KR) 10-2010-0107238

(51) Int. Cl. G06F 17/00; H04L 29/06

(52) U.S. Cl. 726/1

(57) ABSTRACT

Provided are a security information sharing apparatus capable of sharing security information among network domains and a method thereof. The security information sharing apparatus includes a primitive security information storage unit configured to store primitive security information to be shared with other network domains, an information sharing policy storage unit configured to store an information sharing policy for information to be shared, an information masking policy storage unit configured to store an information masking policy for information not to be opened to the other network domain, a domain selector configured to select the other network domain to receive the shared security information, a shared security information generator configured to generate shared security information for the selected other network domain by applying the information sharing policy to the primitive security information, an information masking unit configured to mask information not to be opened in the generated security information according to the information masking policy, a protocol message generator configured to generate a protocol message for the shared security information subjected to the information masking, to be transmitted, and a protocol message transmitter configured to transmit the protocol message to the selected other network domain.

### CLAIM FOR PRIORITY

This application claims priority to Korean Patent Application No. 10-2010-0107238 filed on Oct. 29, 2010 in the Korean Intellectual Property Office (KIPO), the entire contents of which are hereby incorporated by reference.

### BACKGROUND

1. Technical Field

An example embodiment of the present invention relates in general to an apparatus for sharing security information among network domains and a method thereof, and more particularly, to an apparatus for sharing security information among network domains and a method thereof, which enable a variety of security information to be shared among the network domains.

2. Related Art

With the development of communications and network technology, cyber attacks using a network, such as spam, virus, and denial of service/distributed denial of service, have been done using a variety of schemes, and have been evolved into more fatal forms due to a higher propagation speed. Accordingly, many schemes has been proposed in order to protect a network infrastructure from such cyber attacks, but a security issue is still generated as cyber attack schemes become gradually intelligent and advanced.

Accordingly, researches for enabling systematic and comprehensive response on an overall network basis by sharing security information in order to effectively protect against the cyber attacks has been conducted. In particular, a system for rapidly responding to cyber security threats by sharing and managing a variety of security information has been required in a public Internet environment such as government, finance, ISP, and enterprise. When various types of changed or newly created complex threats and attacks are rapidly generated and automatically propagated, it is necessary to share a variety of security information rapidly and effectively.

Conventional technology for sharing security information includes an incident object description and exchange format (IODEF)-based security information sharing method, and an intrusion detection message exchange format (IDMEF)-based security information sharing method. The IODEF-based security information sharing method aims at sharing only infringement accident information, and the IDMEF-based security information sharing method aims at sharing only security log information.

Such conventional security information sharing methods are intended to provide only sharing of single security information, it is difficult to use as technology for sharing various types of security information among network domains. When the security log information is shared, an amount of the shared information may be extraordinarily increased according to strengths and sizes of cyber attacks. A network domain receiving such a great amount of security information may suffer from an issue related to performance. It is difficult to effectively resolve such an issue using conventional technology.

Accordingly, there is a need for a security information sharing method capable of promptly reflecting requirements from each network domain and sharing various types of security information.

### SUMMARY

Example embodiments of the present invention provide an apparatus for sharing security information among network domains which is capable of sharing a variety of security information among the network domains and preventing network overload from being caused by transmission and reception of a great amount of shared security information.

Example embodiments of the present invention also provide a method of the shared security information between network domains which is capable of sharing a variety of security information among the network domains and preventing network overload from being caused by transmission and reception of a great amount of shared security information.

In some example embodiments, a security information sharing apparatus includes a primitive security information storage unit configured to store primitive security information to be shared with other network domains; an information sharing policy storage unit configured to store an information sharing policy for information to be shared with the other network domains; an information masking policy storage unit configured to store an information masking policy for information not to be opened to the other network domains; a domain selector configured to select the other network domain to receive security information to be shared; a security information generator configured to generate security information to be shared with the selected other network domain by applying the information sharing policy to the primitive security information; an information masking unit configured to mask information not to be opened in the shared security information generated by the security information generator according to the information masking policy stored in the information masking policy storage unit; a protocol message generator configured to generate a protocol message for the security information subjected to the information masking, to be transmitted to the selected other network domain; and a protocol message transmitter configured to transmit the protocol message to the selected other network domain.

Here, the primitive security information storage unit may store security log information including cyber attack detection information, and security state information indicating a current state of a network domain.

Here, the information sharing policy stored in the information sharing policy storage unit may be set for each other network domain, and the information sharing policy may include: a security log statistics policy for generating statistics information for the security log information stored in the primitive security information storage unit; a security log filtering policy for filtering the security log information stored in the primitive security information storage unit to generate ultimate security log information; and a security state assembly policy for assembling the security state information stored in the primitive security information storage unit to generate security state information.

Here, the security information generator may include: a security log information statistics unit configured to generate statistics information for the security log information stored in the primitive security information storage unit according to the security log statistics policy; a security log information filtering unit configured to filter the security log information stored in the primitive security log information storage unit according to the security log filtering policy to generate the ultimate security log information; and a security state assembly unit configured to assemble the security state information stored in the primitive security log information storage unit according to the security state assembly policy to generate ultimate security state information.

Here, the security information sharing apparatus may include an information sharing policy agent, the information sharing policy agent setting an information sharing policy for information to be received by the other network domain in response to a request from the other network domain and storing the information sharing policy in an information sharing policy storage unit. The information sharing policy agent may set an information masking policy for information to be transmitted to the other network domain in response to a request from own network domain, and store the information masking policy in an information masking policy storage unit.

Here, the security log information may include a detection time, an attack name, attack severity, an IP address and a port number of an attack system, an IP address and a port number of an attack destination system, and a protocol number, and the security state information may include black list information, Botnet information, infringement accident information, and network traffic information.

Here, both the information sharing policy and the information masking policy may include at least one rule, and each rule may include a condition, and an action according to condition satisfaction, the security log statistics policy may include a condition including a domain name, a calculation period, a top transmission ranking, and a criteria field name, and an action including an output field name and an occurrence count, the security log filtering policy may include a condition including a domain name, a calculation period, a top transmission ranking, and a criteria field name, and an action including security log, the security state assembly policy may include a condition including a domain name and a calculation period, and an action including an output information name, and the information masking policy may include a condition including a domain name and a target field name, and an action including a masking value.

In other example embodiments, a security information sharing method includes a step of storing a primitive security information to be shared with other network domains; a information sharing policy establishment step of establishing and storing an information sharing policy for information to be shared with the other network domains; a masking policy establishment step of establishing and storing an information masking policy for information not to be opened to the other network domains; a domain selection step of selecting the other network domain to receive the security information to be shared; a security information generation step of generating the security information to be shared with the selected other network domain by applying the information sharing policy to the primitive security information; an information masking step of masking information not to be opened in the security information generated in the security information generation step according to the information masking policy stored in an information masking policy storage unit; a protocol message generation step of generating a protocol message for the security information subjected to the information masking, to be transmitted to the selected other network domain; and a protocol message transmission step of transmitting the protocol message to the selected other network domain.

Here, the primitive security information in the primitive security information storing step may include security log information including cyber attack detection information, and security state information indicating a current state of a network domain.

Here, the information sharing policy may include a security log statistics policy for generating statistics information for the security log information, a security log filtering policy for filtering security log information to generate ultimate security log information, and a security state assembly policy for assembling the security state information to generate security state information, and the security information generation step may include a statistics information generation step of generating statistics information for the security log information according to the security log statistics policy; a security log information filtering step of filtering the security log information according to the security log filtering policy to generate the ultimate security log information; and a security state assembly unit of assembling the security state information according to the security state assembly policy to generate ultimate security state information.

Here, the information sharing policy may be set for information to be received by the other network domain in response to a request from the other network domain, and stored in an information sharing policy storage unit.

Here, the information masking policy may be set for information to be transmitted to the other network domain in response to a request from own network domain, and stored in an information masking policy storage unit.

With the apparatus for sharing security information among network domains and a method thereof according to an example embodiment of the present invention, each network domain can individually establish policies for security information to be shared, such that desired information and an amount of the information can be adjusted for each domain. Accordingly, it is possible to prevent network overload from being caused by transmission and reception of a great amount of shared information and share a variety of security information between network domains.

With the apparatus for sharing security information among network domains and a method thereof according to an example embodiment of the present invention, it is also possible for a network domain receiving security information to directly organize necessary security information and a network domain transmitting the security information to conceal information not to be opened so that a variety of information sharing requirements from domains can be reflected.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram showing that security information is shared among network domains through respective security information sharing apparatuses;

FIG. 2 is a block diagram showing components of the security information sharing apparatus according to an example embodiment of the present invention and a relationship among the components;

FIG. 3 is a conceptual diagram showing an example and a structure of data stored in a primitive security information storage unit according to an example embodiment of the present invention;

FIG. 4 is a conceptual diagram showing an example and a configuration of an information sharing policy storage unit and an information masking policy storage unit according to an example embodiment of the present invention; and

FIG. 5 is a flowchart illustrating a process of sharing security information among network domains according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Network domains sharing security information defined in example embodiments of the present invention may be individually divided, independent network domains or network domains receiving a certain network service from a specific network domain. Alternatively, the network domains may be network domains belonging to a specific group and receiving a consistent security policy. The network domains of the security information sharing apparatus according to example embodiments of the present invention are not limited.

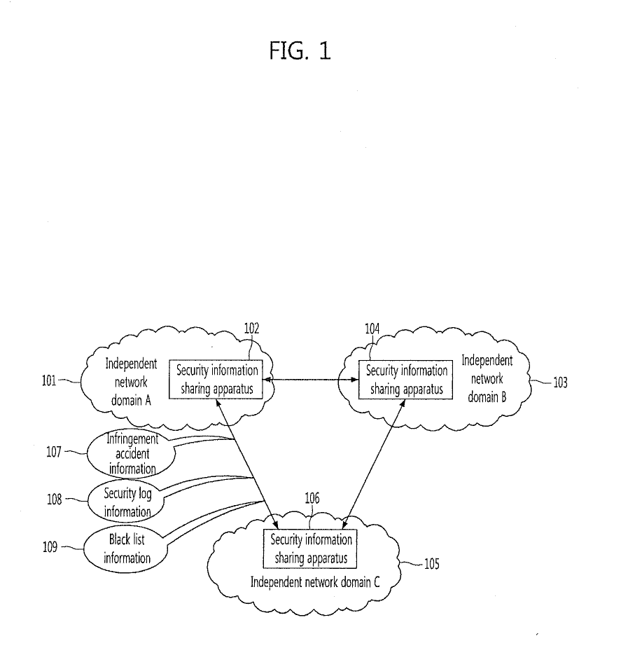

FIG. 1 is a conceptual diagram showing that security information is shared among network domains through respective security information sharing apparatuses.

Referring to FIG. 1, an example in which network domains A 101, B 103 and C 105 share security-related information collected in own networks with the other network domains 101,103 and 105 through own security information sharing apparatuses 102,104 and 106 is shown.

The security information shared among the network domains include a variety of security-related information, such as infringement accident information 107 related to damage caused by a cyber attack, security log information 108 created when the cyber attack is detected, and black list information 109 for frequently found attackers.

However, when all security-related information generated in the network domains are shared, the amounts and types of security information to be shared increase. Accordingly, in the example embodiment of the present invention, an apparatus for defining and sharing only necessary information for each domain and a method thereof, i.e., an apparatus capable of individually reflecting a variety of requirements from respective network domains and a method thereof are disclosed.

Hereinafter, a configuration of the apparatus for sharing security information among network domains and preferred security information policies according to an example embodiment of the present invention, and a method of sharing security information among network domains by applying the security information sharing apparatus and the security information policies according to an example embodiment of the present invention will be described.

Configuration of Security Information Sharing Apparatus According to Example Embodiment

Hereinafter, a configuration of a security information sharing apparatus for sharing security information among network domains according to an example embodiment of the present invention will be described.

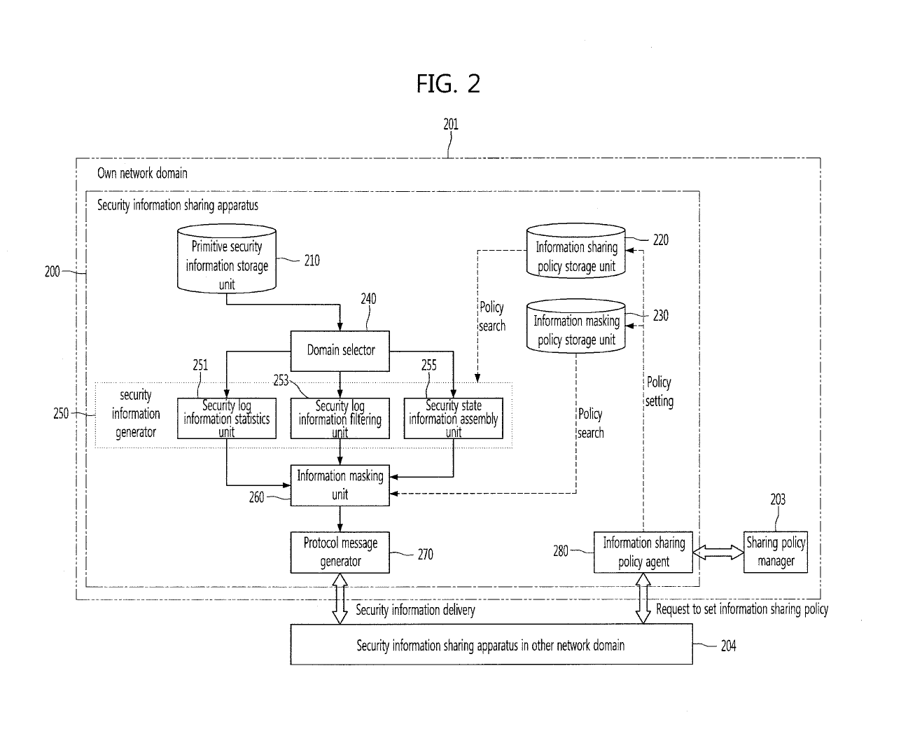

FIG. 2 is a block diagram showing components of the security information sharing apparatus according to an example embodiment of the present invention and a relationship among the components.

Referring to FIG. 2, the security information sharing apparatus 200 according to an example embodiment of the present invention includes a primitive security information storage unit 210, an information sharing policy storage unit 220, an information masking policy storage unit 230, a domain selector 240, a security information generator 250, an information masking unit 260, a protocol message generator 270, and an information sharing policy agent 280.

Hereinafter, each component of the security information sharing apparatus 200 and a role thereof will be described.

The primitive security information storage unit 210 stores primitive security information to be shared among network domains. Generally, the primitive security information storage unit 210 stores security-related log information and infringement accident information. The primitive security information storage unit will be described in greater detail below.

The information sharing policy storage unit 220 stores an information sharing policy for information to be shared with the other network domains, i.e., a policy defined for the information to be shared with the other network domains, and a sharing form. The information sharing policy may be classified into a security log statistics policy, a security log filtering policy, and a security state assembly policy. A configuration of the information sharing policy storage unit and each information sharing policy will be described in detail below.

The information masking policy storage unit 230 stores a policy for masking information not to be opened to the other network domain. A configuration of the information masking policy storage unit and the information masking policy will be described in detail below.

The domain selector 240 selects a network domain that will receive the security information to be shared with, by referencing the primitive security information storage unit 210. That is, it is necessary to select the network domain that will receive the security information to be shared in order to transmit the security information to the network domain. The selection is performed by the domain selector.

The security information generator 250 generates the security information to be transmitted to the network domain selected by the domain selector 240 by applying the information sharing policy stored in the information sharing policy storage unit 220 to the primitive security information. The security information generator 250 is divided into a security log information statistics unit 251, a security log information filtering unit 253, and a security state information assembly unit 255 according to the applied information sharing policy.

The security log information statistics unit 251 generates statistics information for security log information to be transmitted to the network domain selected by the domain selector 240 according to a security log statistics policy.

The security log information filtering unit 253 filters primitive security log information according to a security log filtering policy and generates ultimate security log information to be transmitted to the network domain selected by the domain selector 240.

The security state information assembly unit 255 assembles individual security state information according to a security state assembly policy and generates ultimate security state information to be transmitted to the network domain selected by the domain selector 240.

The information masking unit 260 performs masking on information not to be opened for the statistics information generated by the security log information statistics unit 251, the ultimate security log information generated by the security log information filtering unit 253, and the ultimate security state information generated by the security state information assembly unit 255 according to the information masking policy stored in the information masking policy storage unit 230.

When the masked security information is transmitted to the network domain selected by the domain selector 240, the protocol message generator 270 generates a protocol message for the statistics information, the ultimate security log information, and the ultimate security state information from the information masking unit 260.

The information sharing policy agent 280 newly sets and changes the policies in the information sharing policy storage unit 220 and the information masking policy storage unit 230 in response to requests from the sharing policy manager 203 in own network domain and the security information sharing apparatus 204 in the other network domain.

In particular, the information sharing policy agent 280 of the security information sharing apparatus 200 according to an example embodiment of the present invention enables the security information sharing apparatus 204 in the network domain receiving security information to be shared to directly set the security log statistics policy, the security log filtering policy, and the security state assembly policy in the information sharing policy storage unit 220 of the network domain transmitting the information, such that the receiving network domain can directly organize necessary security information. And the information sharing policy agent 280 also enables only the sharing policy manager 203 in own network domain to directly set the information masking policy in the information masking policy storage unit 230, such that own network domain can keep certain information from being exposed. Thus, it is possible to directly reflect security requirements from several network domains.

Hereinafter, a configuration of the primitive security information storage unit will be described.

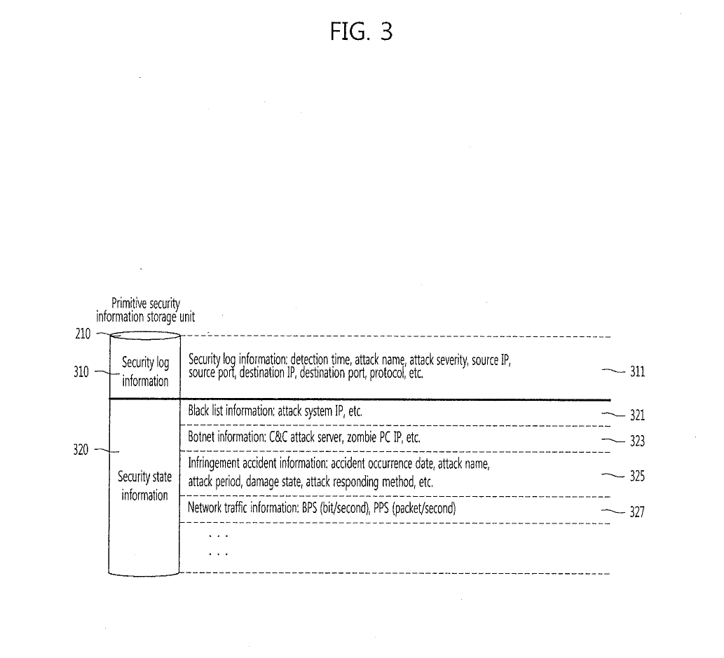

FIG. 3 is a conceptual diagram showing an example and a structure of data stored in the primitive security information storage unit according to an example embodiment of the present invention.

Referring to FIG. 3, the primitive security information storage unit 210 stores security information to be shared with the other network domains. The security information includes security log information 310 as a detailed record of a detected cyber attack, and security state information 320 as analysis information for security-related events.

The security log information 310 may include information such as a detection time, an attack name, attack severity, an IP address and a port number of an attack source system, an IP address and a port number of an attack destination system, and protocol.

The security log information 320 is attack detection information collected from a cyber attack prevention system and a threat management system (TMS), such as an intrusion detection system (IDS), an intrusion prevention system (IPS), and a firewall, and a security management system, such as an enterprise security management system (ESM). The security log information is generally collected from a number of security management systems. Further, since one security management system may generate 1000 security logs per second, a great number of security logs are generally stored in the primitive security information storage unit.

The security state information 320 is information indicating a current security state of the network domain. The security state information 320 may include black list information 321 including an IP address list for systems currently confirmed as attackers, and Botnet information 323 including Botnet detection information such as an IP address of a Botnet control and command (C&C) attack server and an IP address of a zombie PC infected with a virus.

The security state information 320 may further include infringement accident information 325 including infringement accident information such as an accident occurrence date, an attack name, an attack period, a damage state, and an attack responding method when a system is damaged by a cyber attack, network traffic information 327 including network traffic state information such as BPS (bit/second) and PPS (packet/second) of traffic in the network domain, and the like.

Hereinafter, configurations of the information sharing policy storage unit and the information masking policy storage unit and a policy setting example will be described.

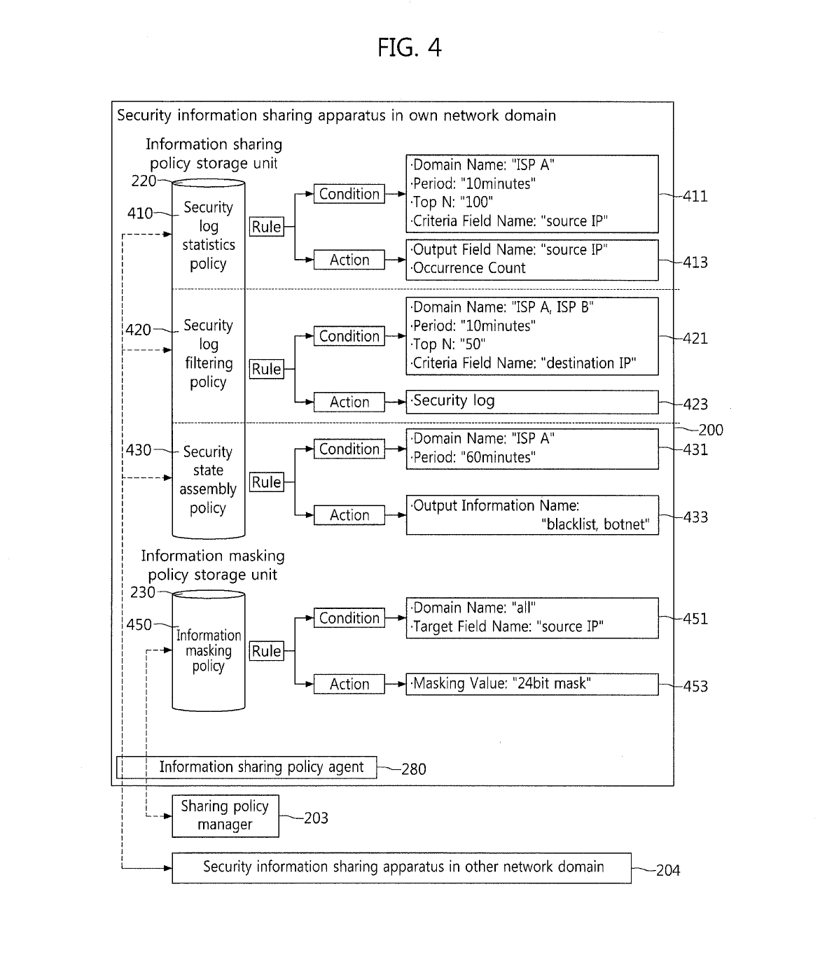

FIG. 4 is a conceptual diagram showing an example and a configuration of the information sharing policy storage unit and the information masking policy storage unit according to an example embodiment of the present invention.

Referring to FIG. 4, three types of policies including a security log statistics policy 410, a security log filtering policy 420, and a security state assembly policy 430 are stored in the information sharing policy storage unit 220. Each policy includes at least one rule, and each rule includes a condition, and an action that is performed when the condition is satisfied.

The security log statistics policy 410 is a policy for generating statistics information for the security log information 310 stored in the primitive security information storage unit 210. A condition 411 to generate the statistics information includes a domain name, a calculation period, a top transmission ranking (top N), and a criteria field name. An action 413 according to the condition includes an output field name and an occurrence count.

Referring to the example of FIG. 4, as the rule of the security log statistics policy 410, the condition is [Domain Name: “ISP A,” Period: “10 minutes,” Top N: “100,” Criteria Field Name: “source IP”] 411, and the action according to the condition is [Output Field Name: “source IP,” Occurrence Count] 413. This indicates a rule to align the security log data stored in the primitive security storage unit 210 every 10 minutes according to a source IP address and generate source IP addresses ranked in top 100 and an occurrence count of the addresses when a transmitting domain is “ISP A.”

The security log filtering policy 420 is a policy to filter the security log information 310 stored in the primitive security information storage unit 210 and generate ultimate security log information to be delivered to the other domain. The filtering condition 421 includes a domain name, a calculation period, top transmission ranking (top N), and a criteria field name. An action 423 includes security log.

Referring to the example of FIG. 4, as the rule of the security log filtering policy 420, the condition is [Domain Name: “ISP A, ISP B,” Period: “10 minutes,” Top N: “50,” Criteria Field Name: “destination IP”] 421, and the action according to the condition is [Security log] 423. This indicates a rule to align the security log data stored in the primitive security storage unit 210 every 10 minutes according to a destination IP address and generate security log information ranked in top 50 when the domain is “ISP A” or “ISP B”.

The security state assembly policy 430 is a policy to assemble individual security state information stored in the primitive security information storage unit 210 and generate ultimate security state information to be delivered to the other domain. The security state assembly condition 431 includes a domain name and a calculation period, and the action 433 includes an output information name.

Referring to the example of FIG. 4, as the rule of the security state assembly policy 430, the condition is [Domain Name: “ISP A,” Period: “60 minutes”] 431, and the action includes [Output Information Name: [“blacklist, Botnet”] 433. This rule indicates that black list information and Botnet information are required to be generated every 60 minutes when the transmitting domain is “ISP A.”

Referring to FIG. 4, the information masking policy 450 is stored in the information masking policy storage unit 230. The information masking policy includes at least one rule, and each rule includes a condition and an action when the condition is satisfied.

The information masking policy 450 is a masking policy to conceal information not to be opened in the security information to be shared. The masking condition 451 includes a domain name and a target field name, and the action 453 according to the condition includes a masking value.

Referring to the example of FIG. 4, as the rule of the information masking policy 450, the condition is [Domain Name: “all,” Target Field Name: “Source IP”] 451, and the action according to the condition includes [Masking Value: “24 4 bit Mask”] 452. This rule indicates that “source IP” information is required to be masked by means of 24 bits when the “source IP” information is included in the security information to be shared.

Structure of Preferred Security Policy According to Example Embodiment

Hereinafter, a structure of a preferred security policy for satisfying security information sharing requirements of a variety of network domains and reducing a network load that may be caused by transmission and reception of excessive sharing information according to an example embodiment of the present invention will be described.

That is, part for enabling a receiving network domain to determine information to be received and an amount of the information, and a transmitting network domain to determine information to be concealed, in a security policy that can be applied in the security information sharing apparatus and method according to an example embodiment of the present invention, will be described by way of example.

Referring to FIG. 4, in the apparatus for sharing security information among network domains according to an example embodiment of the present invention, for dynamical determination of security information to be shared in response to a request from a network domain receiving the information (i.e., the other network domain 204), the information sharing policy agent 280 applies the request from the network domain receiving the information to the security log statistics policy 410, the security log filtering policy 420 and the security state assembly policy 430.

The information masking policy 450 may be set to conceal security information not to be opened in response to a request from the security information sharing apparatus 200 in the network domain transmitting the information (i.e., own network domain).

For example, when a performance issue is caused due to one network domain receiving too much security information, the condition 408 of the security log filtering policy of the transmitting network domain is changed from [Top N: “50”] to [Top N: “10”], so that only fundamental security information ranked in top 10 can be transmitted. When one network domain desires to receive much security information and analyze the security information in detail, the condition 408 of the security log filtering policy of the transmitting network domain is changed from [Top N: “50”] to [Top N: “100”].

In the case of information masking, when there is a requirement that one network domain shares the security log information, but should not open a source IP address, a network domain transmitting the security log information may register the condition for the information masking policy as [target Field Name: “source IP”] and the corresponding action as [Masking Value: “4-bit masking”].

Accordingly, as shown in FIG. 4, the information sharing policy agent 280 of the security information sharing apparatus 200 in own network domain enables the security information sharing apparatus 204 in the other network domain receiving the security information to be shared to directly set the security log statistics policy 410, the security log filtering policy 420, and the security state assembly policy 430 stored in the information sharing policy storage unit 220 in the network domain transmitting the information, such that the receiving network domain can directly organize necessary security information.

The information sharing policy agent 280 of the security information sharing apparatus 200 in own network domain enables only the sharing policy manager 203 in own network domain to directly set the information masking policy 450 stored in the information masking policy storage unit 230, such that own network domain can keep certain information from being exposed. Thus, it is possible to directly reflect security requirements from several network domains.

Method of Sharing Security Information Between Network Domains According to Example Embodiment

Hereinafter, a process of sharing security information using the security information sharing apparatus 200 will be described in detail in connection with a method of sharing security information among network domains according to another example embodiment of the present invention.

In particular, in this embodiment, a process of generating security information to be shared according to the security policy for other network domains that will share security information, and transmitting the security information to the other network domains will be described.

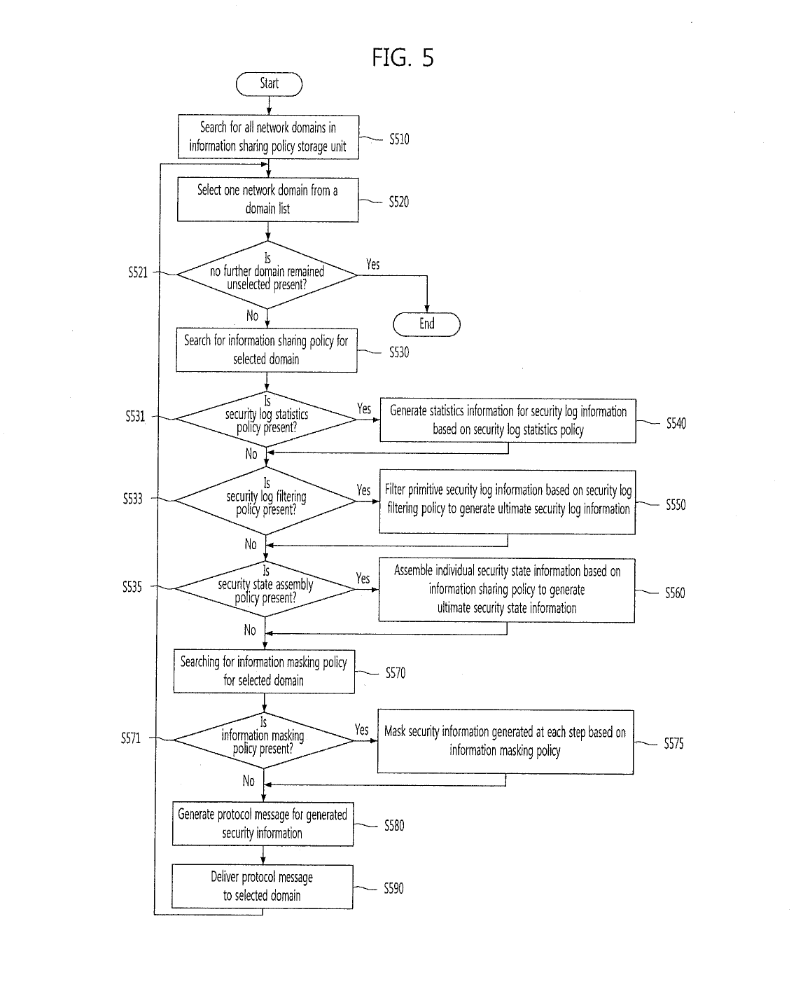

FIG. 5 is a flowchart illustrating a process of sharing security information among network domains according to an example embodiment of the present invention.

Referring to FIG. 5, a process of sharing security information among network domains according to an example embodiment of the present invention includes a step S510 of searching for a network domain, a step S520 of selecting a network domain that will receive information, a step S530 of searching for an information sharing policy, a step S540 of generating security log statistics information, a step S550 for filtering security log, a step S560 of generating security state information, a step S570 of generating an information masking policy, a step S575 of masking security information, a step S580 for generating a protocol message for the security information, and a step S590 of transmitting a protocol message.

In step S510 of searching for a network domain, the domain selector 240 searches for all network domains that will share security information registered in the information sharing policy storage unit 220 of the security information sharing apparatus 200.

Next, in step S520 of selecting a network domain that will receive information, one domain to which the information sharing policy is to be reflected is selected from a list of the searched network domains. In this case, one network domain will be generally selected from aligned network domains in a specific order or in any order. Alternatively, when a specific search condition is given, a domain satisfying the condition may be selected. In this embodiment, a process of selecting all network domains registered in the information sharing policy and sequentially transmitting sharing information to the selected network domains is shown.

In step S530 of searching for an information sharing policy, presence of the security log statistics policy, the security log filtering policy, and the security state assembly policy for the selected domain is recognized by searching for the information sharing policy storage unit 220, and the sharing information to be generated is determined.

When the security log statistics policy for the selected domain is present in the information sharing policy storage unit 220 (S531), the security log statistics policy is applied to the security log information stored in the primitive security information storage unit 210 to generate statistics information (S540).

When the security log filtering policy for the selected domain is present in the information sharing policy storage unit 220 (S533), the security log information stored in the primitive security information storage unit 210 is filtered according to the filtering policy to generate security log information to be ultimately shared (S550).

When the security state assembly policy for the selected domain is present in the information sharing policy storage unit 220 (S535), individual security state information stored in the primitive security information storage unit 210 is assembled to generate security state information to be ultimately shared (S560).

In step S570 of generating an information masking policy, presence of an information masking policy for the selected domain is recognized by searching for the information masking policy storage unit 230.

When the information masking policy related to the selected domain is present in the information masking policy storage unit 230 (S571), the masking policy is applied to the security log statistics information, the filtered security log information, and the security state information, which are the security information generated in steps S540 to S560, for masking (S575).

Next, in step S580 for generating a protocol message for the security information, a protocol message for the security information subjected to the masking step is generated and delivered to the selected network domain (S590).

The processes S520 to S590 of sharing the security information are iteratively performed on all the domains registered in the information sharing policy storage unit.

When the security information is transmitted to other domains as described above, the security information may be collectively transmitted to all the domains at a specific time. Alternatively, in response to a request from a specific network domain, security information may be generated for the requesting network domain and transmitted to the requesting network domain. A method of generating and transmitting the security information (collectively or individually) and a time to generate and transmit are not limited.

While the example embodiments of the present invention and their advantages have been described in detail, it should be understood that various changes, substitutions and alterations may be made herein without departing from the scope of the invention.

What is claimed is:

1. A security information sharing apparatus comprising:
a primitive security information storage unit configured to store primitive security information to be shared with other network domains;
an information sharing policy storage unit configured to store an information sharing policy for security information to be shared with the other network domains;
an information masking policy storage unit configured to store an information masking policy for security information not to be opened to the other network domains;
a domain selector configured to select the other network domain to receive security information;
a security information generator configured to generate security information to be shared with the selected other network domain by applying the information sharing policy to the primitive security information;
an information masking unit configured to mask information not to be opened in the security information to be shared with the selected other network domain according to the information masking policy; and
a protocol message generator configured to generate a protocol message for the security information subjected to the information masking, to be transmitted to the selected other network domain.

2. The security information sharing apparatus according to claim 1,
wherein the primitive security information storage unit stores:
security log information including cyber attack detection information, and
security state information indicating a current state of a network domain.

3. The security information sharing apparatus according to claim 2,
wherein the information sharing policy stored in the information sharing policy storage unit is set for each other network domain, and the information sharing policy includes:
a security log statistics policy for generating statistics information for the security log information stored in the primitive security information storage unit;
a security log filtering policy for filtering the security log information stored in the primitive security information storage unit to generate ultimate security log information; and
a security state assembly policy for assembling the security state information stored in the primitive security information storage unit to generate security state information.

4. The security information sharing apparatus according to claim 3,
wherein the security information generator comprises:
a security log information statistics unit configured to generate statistics information for the security log information stored in the primitive security information storage unit according to the security log statistics policy;
a security log information filtering unit configured to filter the security log information stored in the primitive security log information storage unit according to the security log filtering policy to generate the ultimate security log information; and
a security state assembly unit configured to assemble the security state information stored in the primitive security log information storage unit according to the security state assembly policy to generate ultimate security state information.

5. The security information sharing apparatus according to claim 1, further comprising an information sharing policy agent, the information sharing policy agent setting an information sharing policy for information to be received by the other network domain in response to a request from the other network domain and storing the information sharing policy in an information sharing policy storage unit.

6. The security information sharing apparatus according to claim 5,
wherein the information sharing policy agent sets an information masking policy for security information to be transmitted to the other network domain in response to a request from own network domain, and stores the information masking policy in an information masking policy storage unit.

7. The security information sharing apparatus according to claim 2,
wherein the security log information includes a detection time, an attack name, attack severity, an IP address and a port number of an attack system, an IP address and a port number of an attack destination system, and a protocol number.

8. The security information sharing apparatus according to claim 2,
wherein the security state information includes black list information, Botnet information, infringement accident information, and network traffic information.

9. The security information sharing apparatus according to claim 3,
wherein both the information sharing policy and the information masking policy include at least one rule, and each rule includes a condition, and an action according to condition satisfaction.

10. The security information sharing apparatus according to claim 9,
wherein the security log statistics policy includes a condition including a domain name, a calculation period, a top transmission ranking, and a criteria field name, and an action including an output field name and an occurrence count,
the security log filtering policy includes a condition including a domain name, a calculation period, a top transmission ranking, and a criteria field name, and an action including security log,
the security state assembly policy includes a condition including a domain name and a calculation period, and an action including an output information name, and
the information masking policy includes a condition including a domain name and a target field name, and an action including a masking value.

11. A security information sharing method comprising:
a information sharing policy establishment step of establishing an information sharing policy for security information to be shared with the other network domains;
a masking policy establishment step of establishing an information masking policy for security information not to be opened to the other network domains;
a domain selection step of selecting the other network domain to receive security information;
a security information generation step of generating the security information to be shared with the selected other network domain by applying the information sharing policy to primitive security information;
an information masking step of masking information not to be opened in the security information to be shared with the selected other network domain according to the information masking policy; and
a protocol message generation step of generating a protocol message for the security information subjected to the information masking, to be transmitted to the selected other network domain.

12. The security information sharing method according to claim 11,
wherein the primitive security information includes security log information including cyber attack detection information, and security state information indicating a current state of a network domain.

13. The security information sharing method according to claim 12,
wherein the information sharing policy includes a security log statistics policy for generating statistics information for the security log information, a security log filtering policy for filtering security log information to generate ultimate security log information, and a security state assembly policy for assembling the security state information to generate security state information, and
the security information generation step includes:
a statistics information generation step of generating statistics information for the security log information according to the security log statistics policy;
a security log information filtering step of filtering the security log information according to the security log filtering policy to generate the ultimate security log information; and
a security state assembly unit of assembling the security state information according to the security state assembly policy to generate ultimate security state information.

14. The security information sharing method according to claim 11,
wherein the information sharing policy is set for information to be received by the other network domain in response to a request from the other network domain.

15. The security information sharing method according to claim 14,
wherein the information masking policy is set for information to be transmitted to the other network domain in response to a request from own network domain.
